(19) United States
(12) Patent Application Publication
(10) Pub. No.: US 2017/0069354 A1
(43) Pub. Date: Mar. 9, 2017

(54) METHOD, SYSTEM AND APPARATUS FOR GENERATING A POSITION MARKER IN VIDEO IMAGES

(71) Applicant: CANON KABUSHIKI KAISHA, Tokyo (JP)

(72) Inventors: IJ ERIC WANG, Denistone (AU); ANDREW JAMES DORRELL, Glenbrook (AU)

(21) Appl. No.: 15/257,504

(22) Filed: Sep. 6, 2016

(30) Foreign Application Priority Data
Sep. 8, 2015 (AU) 2015224395

(51) Int. Cl. G11B 27/34; H04N 21/8547; H04N 21/845; H04N 21/472

(52) U.S. Cl. CPC G11B 27/34; H04N 21/47205; H04N 21/8547; H04N 21/8455

(57) ABSTRACT

A method of generating a position marker in video images. The video images are displayed on an interactive display device. An interaction with the interactive display device on the displayed video images is determined during the display of the video images. The position marker is generated, where the position marker is associated with at least one time value determined from the interaction relative to at least one of the video images and is labelled with a graphical representation of the interaction. The graphical representation indicates relative spatial position of the determined interaction on the video image.

REFERENCE TO RELATED PATENT APPLICATION(S)

This application claims the benefit under 35 U.S.C. §119 of the filing date of Australian Patent Application No. 2015224395, filed 8 Sep. 2015, hereby incorporated by reference in its entirety as if fully set forth herein.

### TECHNICAL FIELD

The present invention relates to cinematography and digital cinema. In particular, the present invention relates to a method, apparatus and system for generating a position marker in video images. The present invention also relates to a computer program product including a computer readable medium having recorded thereon a computer program for generating a position marker in video images.

### BACKGROUND

The advent of digital imaging technology has altered the behaviour of the film industry, in the sense that more and more films are produced digitally. Digital cinematography, the process of capturing video content as digital content items, has become increasingly prevalent for film production.

During the capture of video content in the form of a sequence of video images it is frequently necessary to identify time positions in the video content so quick access and searching can be performed by reviewers and editors. The identification of time positions to create position markers in the video content is referred to as “bookmarking”. One bookmarking method allows a user to click a user interface device to generate a position marker within a sequence of video images while the video content is being previewed. A problem with the above bookmarking method is that the user has to subsequently add other metadata to annotate video images, such as keywords and voice notes, to explain the purpose of the position marker. As a result, a separate input step is used to collect the annotation data using a keyboard or other input device. In addition to the input of the annotation data, a label for presenting to a user is required for indexing and subsequent access to the position marker by the user. A separate input step is used to create such a label.

The above described bookmarking method works well where video content being bookmarked is pre-recorded and the user has the ability to pause and review the content. During live video bookmarking, it is often not practical to pause and review the content. In the live video bookmarking, the combination of three independent tasks—of selecting a time position, creating an annotation and creating a label—makes the bookmarking method impractical.

One solution to the above problem is to use a thumbnail of a video image (or ‘video frame’) corresponding to the position marker as a label. The use of a thumbnail allows the label to be created automatically by the system without user interaction. However, there are many situations where a video image at a particular time is not sufficiently different from other video images to make the video image useful as a position marker label. In addition, the video image provides no information about the reason for the position marker creation. Thus, the use of a thumbnail as a label of position marker may not effectively communicate desired information to a second person involved in the creation or editing of the video content.

Instead of using video image data, other metadata can be used to generate a label for a position marker. One example method employs an analogue clock face to automatically annotate the time and duration of a position marker. While the analogue clock face can be useful for specific types of content, the clock face provides poor differentiation where many position markers are employed. In general, metadata suffers from the same problems as any other automatic labelling in that metadata may not capture anything that is directly related to the purpose of position marker.

As mentioned above, voice recording can be employed to annotate position markers. The voice recording method is not practical in the context of live video content production where the act of creating the voice annotation would interfere with the video content being recorded.

Thus, there remains a need to provide an improved system which supports time efficient bookmarking and annotation of video content that can be used during live capture of the video content.

### SUMMARY

It is an object of the present invention to substantially overcome, or at least ameliorate, one or more disadvantages of existing arrangements.

Disclosed are arrangements which seek to address the above problems by performing annotation on a sequence of video images by direct interaction with the live preview of the video images. An interaction takes the form of a gesture that produces a sequence of drawing strokes. The drawing strokes may be grouped to form a graphical representation of the annotation which is subsequently used as a label for the annotation's position marker. The relative position of the annotation strokes within a video image is retained in the graphical representation as the relative position adds contextual information which would otherwise be lost. An annotation interval may be used to determine the properties of a position marker allowing the video images to be annotated and the annotation to be provided with a label in a minimal and time efficient manner An interaction may also take the form of a gesture that identifies a spatial region in the videos images for camera operations. The interaction may generate a position marker. The process and utility of labelling the position marker with a graphical representation retaining the relative position of the interaction, may also be performed in a time efficient manner

According to one aspect of the present disclosure, there is provided a method of generating a position marker in video images, said method comprising:

displaying the video images on an interactive display device;

determining an interaction with the interactive display device on the displayed video images during the display of the video images;

generating the position marker, wherein the position marker is associated with at least one time value determined from the interaction relative to at least one of said video images and is labelled with a graphical representation of the interaction, the graphical representation indicating relative spatial position of the determined interaction on said video image.

According to another aspect of the present disclosure there is provided an apparatus for generating a position marker in video images, said apparatus comprising:

display module for displaying the video images on an interactive display device;

determining module for determining an interaction with the interactive display device on the displayed video images during the display of the video images;

generating module for generating the position marker, wherein the position marker is associated with at least one time value determined from the interaction relative to at least one of said video images and is labelled with a graphical representation of the interaction, the graphical representation indicating relative spatial position of the determined interaction on said video image.

According to still another aspect of the present disclosure there is provided a system for generating a position marker in video images, said system comprising:

a memory for storing data and a computer program;

a processor coupled to the memory for executing the computer program, the computer program comprising instructions for:
displaying the video images on an interactive display device;
determining an interaction with the interactive display device on the displayed video images during the display of the video images;
generating the position marker, wherein the position marker is associated with at least one time value determined from the interaction relative to at least one of said video images and is labelled with a graphical representation of the interaction, the graphical representation indicating relative spatial position of the determined interaction on said video image.

According to still another aspect of the present disclosure there is provided a non-transitory computer readable medium having a computer program stored thereon for generating a position marker in video images, said program comprising:

code for displaying the video images on an interactive display device;

code for determining an interaction with the interactive display device on the displayed video images during the display of the video images;

code for generating the position marker, wherein the position marker is associated with at least one time value determined from the interaction relative to at least one of said video images and is labelled with a graphical representation of the interaction, the graphical representation indicating relative spatial position of the determined interaction on said video image.

Other aspects are also disclosed.

### BRIEF DESCRIPTION OF THE DRAWINGS

One or more embodiments of the invention will now be described with reference to the following drawings, in which:

FIG. 1 is a schematic representation of a traditional workflow used for video and film production;

FIG. 2 is a schematic representation of an architecture within which video capture and annotation may be performed in accordance with the present disclosure;

FIG. 3 shows a user interface for reviewing and annotating video content;

FIG. 4 is a flow diagram of a method of viewing and applying an annotation to a portion of a sequence of video images;

FIG. 5 is a flow diagram showing a method of processing annotation data;

FIG. 6 is a flow diagram showing a method of generating a position marker;

FIG. 7 is a flow diagram showing a method of accessing video and annotation data for a position marker;

FIG. 8 shows examples of annotations that can be generated by the system of FIG. 2 and an example of a corresponding label generated by the method of FIG. 6; and

FIGS. 9A and 9B collectively form a schematic block diagram representation of an electronic device upon which described arrangements can be practised.

### DETAILED DESCRIPTION INCLUDING BEST MODE

Narrative films, which are probably the most widely screened films in theatres, are one type of film product that tells a story. The goal of narrative film making is to compose a sequence of events in audio and/or visual form based on a written (fiction or fictionalized) story. With the advent of digital imaging technology, digital cinematography, being high-quality acquisition of video image data using digital cinema cameras during film production, has become increasingly widespread for narrative film making Similarly, digital cinematography is finding increasing application in other types of films, such as documentary films, examples of which include those based on pre-historic Earth and astronomical science, as well as short-form films and commercials. Digital cinematography is also increasingly practised in digital video productions such as wedding videos, concert videos, and so on.

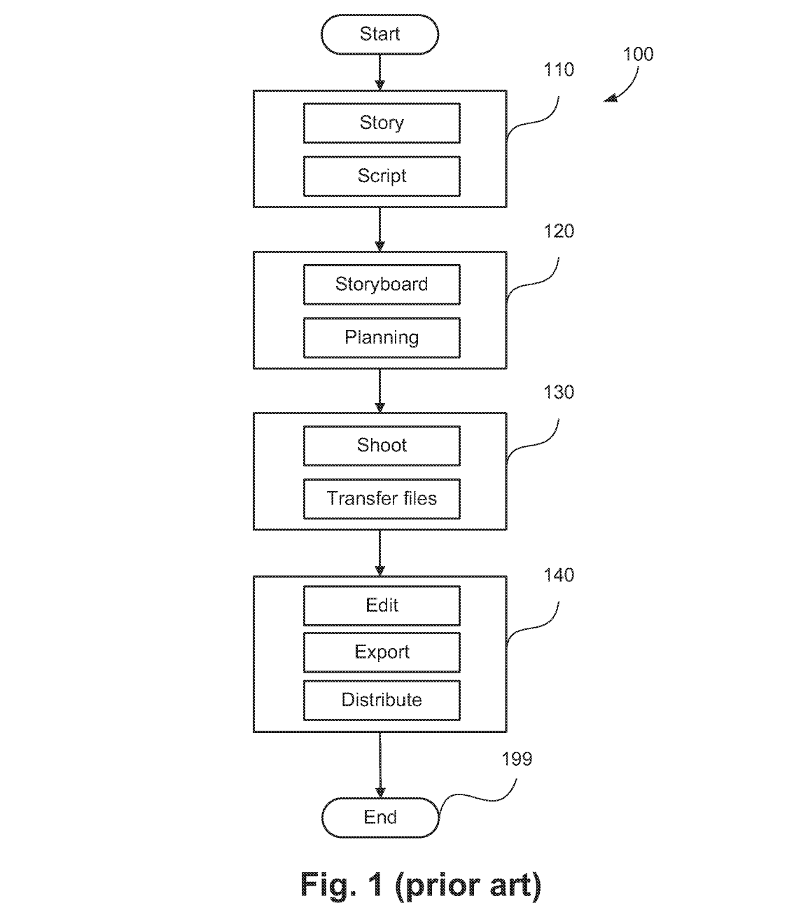

FIG. 1 shows a method 100 representative of a workflow used in digital cinematography for narrative and other types of film making The method 100 mainly comprises the following stages: a development stage 110, a pre-production stage 120, a production stage 130, and a post-production stage 140. The stages 110 to 140 are typically executed in sequence to produce a final film. Variations of the method 100 of FIG. 1 are possible in practice. However, film making typically employs pre-production (planning), production (capture) and post-production (editing) stages in some form.

At the development stage 110, a film producer selects a story and develops a script with the help of a screenwriter. During the development stage 110, key elements such as financing, and confirming principal cast members, directors, and cinematographers for the film.

Following the development stage 110 is the pre-production stage 120. At the pre-production stage 120, storyboards, which are images helping to communicate ideas for the script, are developed. Furthermore, during the pre-production stage 120, each step of actually making the film is designed and planned.

Following the pre-production stage 120 is the production stage 130. At the production stage 130, raw footage for the film is generated. In particular, shots, which are short recorded video image sequences, are captured and/or recorded for different scenes of the film. Shots are captured using an image capture apparatus, such as a digital video camera. A shot is a basic unit of the production stage 130 corresponding to a continuous recording of a scene of the film from the time the image capture apparatus starts recording until the time the image capture apparatus stops recording. It is common to capture multiple alternative versions for any given shot (or ‘scene’) at the production stage 130. Acquiring multiple shots for a given scene helps ensure there is footage of sufficient quality for use in the post-production stage 140. Each alternative shot captured is referred to as a take. Each shot captured is stored with associated metadata relating to the captured video sequence. The production stage 130 traditionally has the greatest cost and requires the greatest level of coordination. The production stage 130 uniquely involves the synchronous coordination of a large number of distinct roles, bringing challenges in the area of communication and the organisation of captured information.

Following the production stage 130 is the post-production stage 140. At the post-production stage 140, the captured shots are edited and then exported to various formats such as Digital Versatile Disc (DVD), Blue-ray Disc (BD), Holographic Versatile Disc (HVD), etc. for distribution. The editing process of the post-production stage 140 consists of reviewing the video content and assembling the film. Metadata created in the production stage 130 is utilized for editing at the post-production stage 140. For example, colour grading may be utilized to enhance or alter the colour of a particular scene of the acquired shots, in light of a cinematographer's or director's notes on colours.

At the production stage 130, a group of people is hired by the production company for the purpose of producing the film product. Such a group is often referred to as the ‘film crew’. ‘Cast’ is another group of people hired for the film production comprising actors who appear in the film or provide voices for characters in the film. A film crew can be partitioned into different departments such as camera department, art department, costume department, etc. Each of these departments includes technical experts that focus in one specific aspect of the film production and is known as the role of a film crew. For example, a film director controls a film's artistic and dramatic aspects by guiding the film crew and the cast in fulfilling the film director's vision. A script supervisor oversees the continuity of the video production which includes props, set dressing, makeup and the actions of the actors during a scene. A camera operator, also called a cameraman, is responsible for operating the video camera to maintain composition and camera angles throughout a given scene or shot. The leading camera operator is often called the cinematographer. A focus puller, or 1^{st} assistant camera, also operates the video camera to maintain image sharpness on the subject or action being filmed.

It is important to organise the video content that was captured (or ‘recorded’) and keep good records of what went on during the production stage 130. Once the video process enters the post-production 140, editors will then be able to quickly find every bit of video content that was captured. Currently, several different kinds of logs or reports are used in the production stage 130, including a list of what video content has been captured and where to find the video content. Quite often, during the production of films, the script supervisor creates a continuity script to detail, for example, camera angles, lens used, any issues, which video clip is a good take, etc.

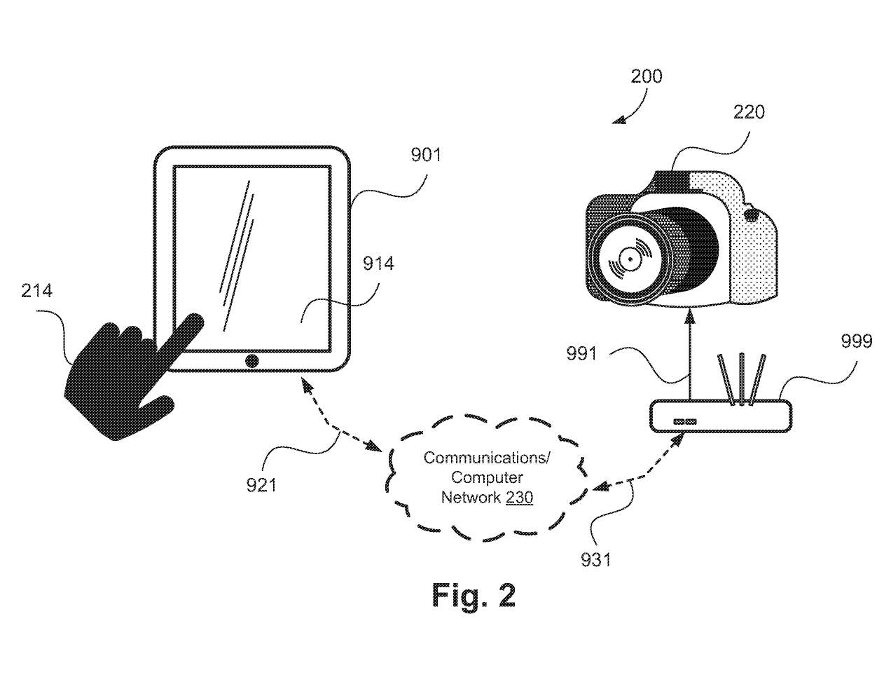

One example of a system 200 upon which arrangements described can be practised is shown in FIG. 2. The system 200 uses digital cinematography, where acquired video content may be monitored remotely with the use of wireless encoders and mobile devices. The system 200 comprises an image capture device 220. In the example of FIG. 2, the image capture device 220 is in the form of a digital video camera. The camera 220 is used to capture the video content in the form of a sequence of video images. The video content is often characterised by the number of video images per unit of time. For example, films are often captured at twenty-four (24) frames per second, where a frame represents one video image. The camera 220 is connected by a communications network 230 to a portable electronic device 901 which will be described in more detail below.

The communications network 230 may be in the form of (i) a wired network such as Ethernet, DSL/ADSL, cable, dial-up, power-line communication (PLC), (ii) a wireless network such as Bluetooth, satellite, Wi-Fi, mobile telephony; or (iii) a hybrid wired and wireless networks.

As described in detail below, the device 901 consists of a touch-sensitive panel display physically associated with an electronic visual display 914 to collectively form a touch-sensitive display (or ‘touch-screen) allowing a user to control the device 901 by touching the screen with one or more fingers 214.

In the example arrangement of FIG. 2, the device 901 is configured for communication with the camera 220 via a connection 921 to communications network 230 and a connection 931 from communications network 230. In the specific example of FIG. 2, the camera 220 is shown interfaced to the network 230 via a wireless encoder 999, such as a Teradek Cube™, and an interconnection 991 such as a HDMI or HD-SDI connection. The Teradek Cube™ may act as a Wi-Fi (IEEE 802.11) hotspot, which the device 901 can connect to and communicate via. In some arrangements, the wireless encoder 999 is internal to the camera 220 and the two are coupled by an internal connection 991. In such arrangements, the camera 200 can wirelessly transmit live video images to the communications network 230 via a Wi-Fi router or a cellular base station.

Once connected to the camera 220, the Teradek Cube™ transmits live video images (live capture of shots) from the camera 220 to the device 901 via connections 921 and 931, where the connections 921 and 931 may use a network protocol such as RTSP (Real Time Streaming Protocol). The device 901 is then used for live (or real-time) preview where the video images are displayed as the video images are being captured by the camera 220. Other methods of live preview may also be used. For example, some camera equipment may integrate wireless broadcast of a viewfinder image using a range of video formats such as motion JPEG, MPEG or H.264 and over one of a range of wireless communications standards such as IEEE 802.11 family (Wi-Fi) or Bluetooth. Further, the camera 220 may be controlled using the device 901, via the connections 921 and 931, where the device 901 comprises a designated camera control function. To facilitate such control, a wireless controller 999 may be employed to allow connection between the camera 220 and external actuators such as focus controllers, and software running on the device 901. The connections 921 and 931 may utilise the network protocol HTTP (Hypertext Transfer Protocol) to access web services provided by the camera 220.

More than one device 901 can be connected to the camera 220, and each device 901 may perform a limited set of functions depending on the aspect of the film production or the role that the user operating the device 901 is responsible for. Further, the same user role may perform different sets of functions depending on the project characteristics of the film production. For example, in a feature film production, a cinematographer may only be responsible for the exposure settings (such as aperture, ISO, and shutter speed) of the camera 220. However, in a documentary film production, a cinematographer may perform both exposure settings and focus control functions on the camera 220 using the device 901.

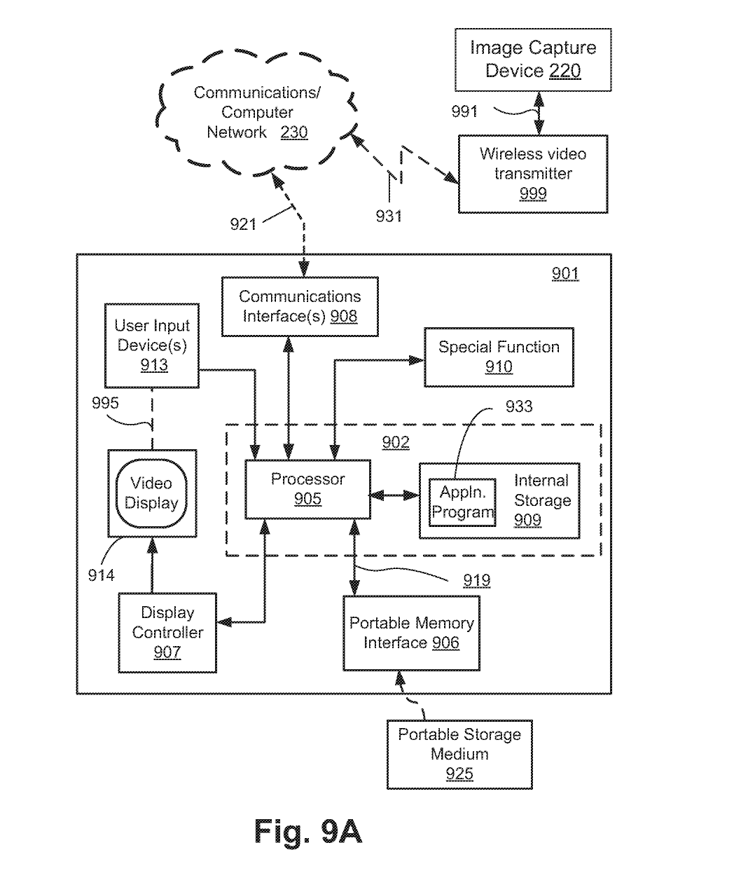

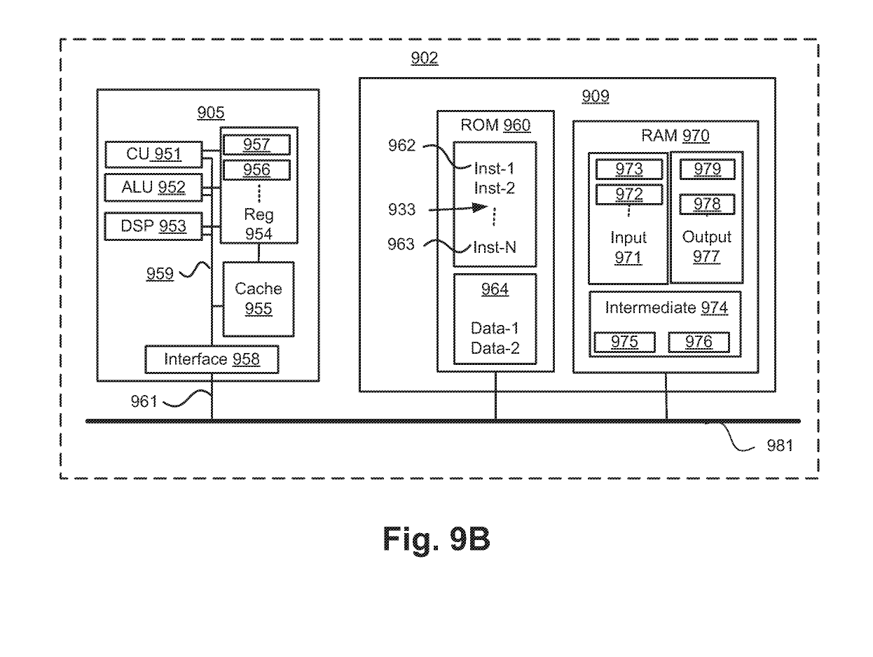

The methods described are typically implemented using at least one portable electronic device 901 such as a tablet, a smartphone, or the like, operating as an interactive display device. The display 914 of the device 901 is suited to real-time video reproduction. FIGS. 9A and 9B collectively form a schematic block diagram of a general-purpose electronic device 901 including embedded components, upon which the methods to be described are desirably practiced. In a preferred implementation, the device 901 is a tablet device having a touch-sensitive display, such as an Apple iPad™. However, in other implementations the electronic device 901 may be another type of electronic device in which processing resources are limited, for example a mobile phone, a portable media player, a field monitor, a recording device, or a smartphone, or an electronic image capture apparatus such as a camera or video camera, all of which may be collectively referred to as interactive display devices. Nevertheless, the methods to be described may also be performed on higher-level interactive display devices such as desktop computers, server computers, and other such devices with significantly larger processing resources.

As seen in FIG. 9A, the device 901 comprises an embedded controller 902. Accordingly, the device 901 may be referred to as an “embedded device.” In the present example, the controller 902 has a processing unit (or processor) 905 which is bi-directionally coupled to an internal storage module 909. The storage module 909 may be formed from non-volatile semiconductor read only memory (ROM) 960 and semiconductor random access memory (RAM) 970, as seen in FIG. 9B. The RAM 970 may be volatile, non-volatile or a combination of volatile and non-volatile memory.

The device 901 includes a display controller 907, which is connected to a video display 914, such as a liquid crystal display (LCD) panel or the like. The display controller 907 is configured for displaying bitmap and graphical images on the video display 914 in accordance with instructions received from the embedded controller 902, to which the display controller 907 is connected.

The device 901 also includes user input devices 913 which are typically formed by keys, a keypad or like controls. As above, in the example described herein, the user input devices 913 includes a touch sensitive panel physically associated with the display 914 to collectively form a touch-sensitive display (or touch screen). For ease of reference, the combination of the display 914 and the user input devices 913 is referred to as the touch-sensitive display 914 in the arrangements described, consistent with that type of structure as found in tablet devices, such as the Apple iPad™. The touch-sensitivity display 914 may thus operate as one form of graphical user interface (GUI) as opposed to a prompt or menu driven GUI typically used with keypad-display combinations. Other forms of user input devices may also be used, such as a microphone (not illustrated) for voice commands or a joystick/thumb wheel (not illustrated) for ease of navigation about menus.

As seen in FIG. 9A, the device 901 also comprises a portable memory interface 906, which is coupled to the processor 905 via a connection 919. The portable memory interface 906 allows a complementary portable memory device 925 to be coupled to the device 901 to act as a source or destination of data or to supplement the internal storage module 909. Examples of such interfaces permit coupling with portable memory devices such as Universal Serial Bus (USB) memory devices, Secure Digital (SD) cards, Personal Computer Memory Card International Association (PCMIA) cards, optical disks and magnetic disks.

The device 901 also has a communications interface 908 to permit coupling of the device 901 to a computer or the communications network 230 via a connection 921. The connection 921 may be wired or wireless. For example, the connection 921 may be radio frequency or optical. An example of a wired connection includes Ethernet. Further, an example of wireless connection includes Bluetooth™ type local interconnection, Wi-Fi (including protocols based on the standards of the IEEE 802.11 family), Infrared Data Association (IrDa) and the like. In the preferred implementation, the communications interface operates according to Wi-Fi standards.

In some instances, the device 901 is configured to perform some special function. The embedded controller 902, possibly in conjunction with further special function components 910, is provided to perform that special function. For example, where the device 901 is a digital camera, the components 910 may represent a lens, focus control and image sensor of the camera. The special function component 910 is connected to the embedded controller 902. As another example, the device 901 may be a mobile telephone handset. In this instance, the components 910 may represent those components required for communications in a cellular telephone environment. Where the device 901 is a portable device, the special function components 910 may represent a number of encoders and decoders of a type including Joint Photographic Experts Group (JPEG), (Moving Picture Experts Group) MPEG, MPEG-1 Audio Layer 3 (MP3), and the like. The special function components 910 may also relate to operation of the touch-sensitive display 914.

The methods described hereinafter may be implemented using the embedded controller 902, where the processes of FIGS. 2 to 8 may be implemented as one or more software application programs 933 executable within the embedded controller 902. The device 901 of FIG. 9A implements the described methods. In particular, with reference to FIG. 9B, the steps of the described methods are effected by instructions in the software 933 that are carried out within the controller 902. The software instructions may be formed as one or more code modules, each for performing one or more particular tasks. The software may also be divided into two separate parts, in which a first part and the corresponding code modules perform the described methods and a second part and the corresponding code modules manage a user interface between the first part and the user.

The software 933 of the embedded controller 902 is typically stored in the non-volatile ROM 960 of the internal storage module 909. The software 933 stored in the ROM 960 can be updated when required from a computer readable medium or via communication with a server computer such as a cloud computer. The software 933 can be loaded into and executed by the processor 905. In some instances, the processor 905 may execute software instructions that are located in RAM 970. Software instructions may be loaded into the RAM 970 by the processor 905 initiating a copy of one or more code modules from ROM 960 into RAM 970. Alternatively, the software instructions of one or more code modules may be pre-installed in a non-volatile region of RAM 970 by a manufacturer. After one or more code modules have been located in RAM 970, the processor 905 may execute software instructions of the one or more code modules.

The application program 933 is typically pre-installed and stored in the ROM 960 by a manufacturer, prior to distribution of the tablet device 901. However, in some instances, the application programs 933 may be supplied to the user encoded on one or more CD-ROM (not shown) and read via the portable memory interface 906 of FIG. 9A prior to storage in the internal storage module 909 or in the portable memory 925. In another alternative, the software application program 933 may be read by the processor 905 from the network 920, or loaded into the controller 902 or the portable storage medium 925 from other computer readable media. Computer readable storage media refers to any non-transitory tangible storage medium that participates in providing instructions and/or data to the controller 902 for execution and/or processing. Examples of such storage media include floppy disks, magnetic tape, CD-ROM, a hard disk drive, a ROM or integrated circuit, USB memory, a magneto-optical disk, flash memory, or a computer readable card such as a PCMCIA card and the like, whether or not such devices are internal or external of the device 901. Examples of transitory or non-tangible computer readable transmission media that may also participate in the provision of software, application programs, instructions and/or data to the device 901 include radio or infra-red transmission channels as well as a network connection to another computer or networked device, and the Internet or Intranets including e-mail transmissions and information recorded on Websites and the like. A computer readable medium having such software or computer program recorded on it is a computer program product.

The second part of the application programs 933 and the corresponding code modules mentioned above may be executed to implement one or more graphical user interfaces (GUIs) to be rendered or otherwise represented upon the display 914 of FIG. 9A. Through manipulation of the user input device 913 (e.g., the keypad or touch-sensitive display), a user of the device 901 and the application programs 933 may manipulate the interface in a functionally adaptable manner to provide controlling commands and/or input to the applications associated with the GUI(s). Other forms of functionally adaptable user interfaces may also be implemented, such as an audio interface utilizing speech prompts output via loudspeakers (not illustrated) and user voice commands input via the microphone (not illustrated).

FIG. 9B illustrates in detail the embedded controller 902 having the processor 905 for executing the application programs 933 and the internal storage 909. The internal storage 909 comprises read only memory (ROM) 960 and random access memory (RAM) 970. The processor 905 is able to execute the application programs 933 stored in one or both of the connected memories 960 and 970. When the device 901 is initially powered up, a system program resident in the ROM 960 is executed. The application program 933 permanently stored in the ROM 960 is sometimes referred to as “firmware”. Execution of the firmware by the processor 905 may fulfil various functions, including processor management, memory management, device management, storage management and user interface.

The processor 905 typically includes a number of functional modules including a control unit (CU) 951, an arithmetic logic unit (ALU) 952, a digital signal processor (DSP) 953 and a local or internal memory comprising a set of registers 954 which typically contain atomic data elements 956, 957, along with internal buffer or cache memory 955. One or more internal buses 959 interconnect these functional modules. The processor 905 typically also has one or more interfaces 958 for communicating with external devices via system bus 981, using a connection 961.

The application program 933 includes a sequence of instructions 962 through 963 that may include conditional branch and loop instructions. The program 933 may also include data, which is used in execution of the program 933. This data may be stored as part of the instruction or in a separate location 964 within the ROM 960 or RAM 970.

In general, the processor 905 is given a set of instructions, which are executed therein. This set of instructions may be organised into blocks, which perform specific tasks or handle specific events that occur in the tablet device 901. Typically, the application program 933 waits for events and subsequently executes the block of code associated with that event. Events may be triggered in response to input from a user, via the user input devices 913 of FIG. 9A, as detected by the processor 905. Events may also be triggered in response to other sensors and interfaces in the device 901.

The execution of a set of the instructions may require numeric variables to be read and modified. Such numeric variables are stored in the RAM 970. The methods described use input variables 971 that are stored in known locations 972, 973 in the memory 970. The input variables 971 are processed to produce output variables 977 that are stored in known locations 978, 979 in the memory 970. Intermediate variables 974 may be stored in additional memory locations in locations 975, 976 of the memory 970. Alternatively, some intermediate variables may only exist in the registers 954 of the processor 905.

The execution of a sequence of instructions is achieved in the processor 905 by repeated application of a fetch-execute cycle. The control unit 951 of the processor 905 maintains a register called the program counter, which contains the address in ROM 960 or RAM 970 of the next instruction to be executed. At the start of the fetch execute cycle, the contents of the memory address indexed by the program counter is loaded into the control unit 951. The instruction thus loaded controls the subsequent operation of the processor 905, causing for example, data to be loaded from ROM memory 960 into processor registers 954, the contents of a register to be arithmetically combined with the contents of another register, the contents of a register to be written to the location stored in another register and so on. At the end of the fetch execute cycle the program counter is updated to point to the next instruction in the system program code. Depending on the instruction just executed this may involve incrementing the address contained in the program counter or loading the program counter with a new address in order to achieve a branch operation.

Each step or sub-process in the processes of the methods described below is associated with one or more segments of the application program 933, and is performed by repeated execution of a fetch-execute cycle in the processor 905 or similar programmatic operation of other independent processor blocks in the tablet device 901.

As described above and as seen in FIG. 9A, the interactive display device in the form of the device 901 is configured for communication with the camera 220 via a connection 921 to the network 230 and a connection 931 from the network 230. In this specific example, the camera 220 is shown interfaced to the network 230 via a wireless video transmitter 999, such as the Teradek Cube™ device mentioned above, which is connected to the communication network 230 via the connection 931. In an alternative implementation, the camera 220 is integrally formed with the wireless video transmitter 999.

In the example of FIG. 9A, the image capture apparatus is a digital video camera 220. In other implementations, the image capture apparatus may be any other device capable of capturing and/or recording video content in the form of a sequence of video images. In an alternative embodiment, the device 901 is integrally formed with the image capture device 220.

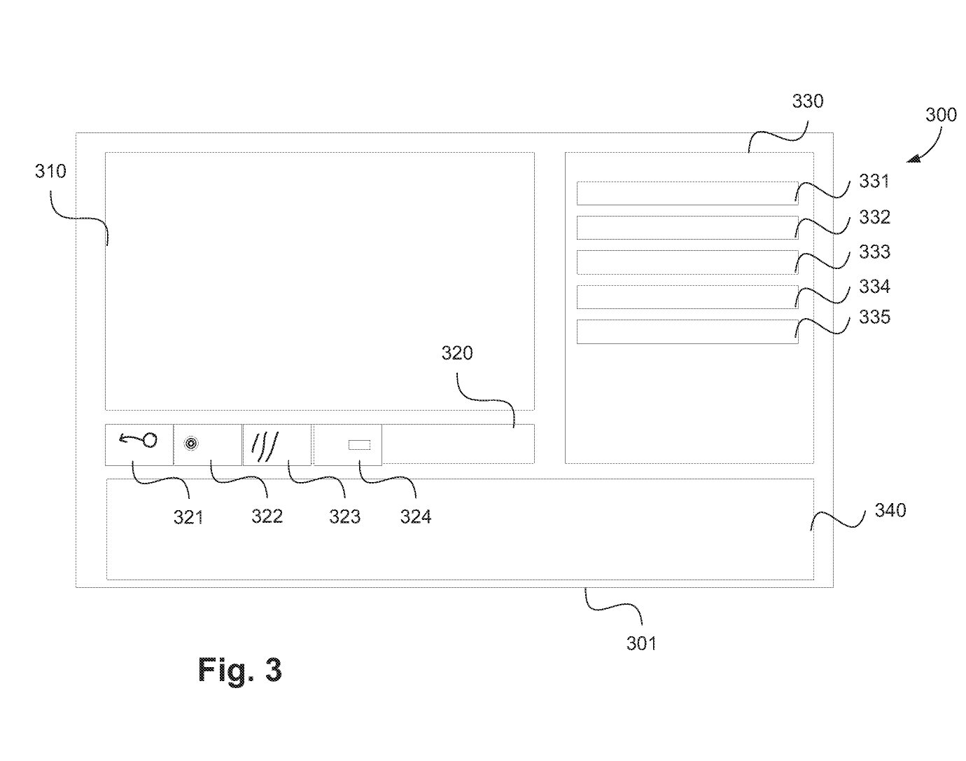

FIG. 3 shows an interface 300 for reviewing and generating position markers for video content during film production. The interface 300 may be displayed on the device 901. The interface 300 is displayed on the touch-sensitive display 914. The interface 300 may be implemented as a full screen application on the device 901. As seen in FIG. 3, application interface area 301 is divided into a video preview area 310 displaying video content, in the form a sequence of video images, captured or being captured by the camera 220; a control area 330 containing interface elements 331-335 that allow for the adjustment of parameters or control settings on the camera 220. The arrangement of the application interface area 301 may vary according to the aspect of the film production for which a user operating the device 901 is responsible. The aspect of the film production that the user operating the device 901 is responsible for is commonly known as ‘the role’ of the user. In some cases, the arrangement of the application interface area 301 may be the same for different user roles. However, functions performed by the divided application interface areas 310, 330, and interface elements 331-335 may be different. In the example of FIG. 3, the interface elements 331-335 may be used by a cinematographer to adjust exposure settings of the camera 220. Such exposure settings may include ISO values, shutter speed, aperture sizes, colour temperature, etc. The interface elements 331-335 may be used by a 1^{st} assistant camera operator, for example, to enter metadata such as slate number for an upcoming shot, location, time, etc.

The interface elements 331-335 may be implemented using sliders and buttons (including check buttons and radio buttons) but may include more complex elements where appropriate. As seen in FIG. 3, a status area 340 provides feedback on current operations. The feedback may be in the form of such things including image histogram plots, sound levels, information about the current point in the storyboard including script elements and direction notes or any other information that may be useful. Like the interface areas 310, 330, and interface elements 331-335, elements of the status area are also variable and determined by the role of a user.

In addition to the interface elements 331-335 in the application interface area 330, control of production parameters, including control over the operation of the camera 220, may be achieved by direct interaction by a user of the device 901 with the video preview area 310 as the user makes contact (i.e., using one or more fingers 214) with the video preview area 310 displayed on the touch-sensitive display 914. The making of contact with the video preview area 310 may be referred to as a “multi-touch operation”. A particular combination of contacts may be referred to as a multi-touch gesture. In the preferred implementation, the device 901 supports a range of single and multi-touch gestures such as a tap, double tap, a pinch, a two finger rotate, stroking out a line, multi-finger swipe and the like as supported by conventional interactive display devices (e.g., the Apple iPad™)

The functions performed by the multi-touch gestures may be variable and determined by the role of the user. For example, a director may use the multi-touch operation to mark the video content displayed in the video preview area 310 on the display 914 of the device 901. The resulting marks as a result of the multi-touch operation can then be used as annotations to the video content. One use of such annotations is by editors in post-production. A cinematographer may use the multi-touch operation to meter the exposure of a region in the video content displayed in the video preview area 310 on the display 914. The 1^{st} assistant camera may use the multi-touch operation to adjust the focus parameters of the camera 220 that provides the video content in the form of video images displayed in the video preview area 310.

Despite the convenience of annotation through multi-touch operation described above, gestures typically only support a restricted range of operations. For addition of complex information such as names and labels it is often necessary to provide a keyboard or voice input device. The keyboard or voice input device may be a significant impediment to real-time annotation where labels need to be associated with annotations in order for the annotations to be indexed and a position marker provided for future access to the annotated content.

The arrangements described provide an efficient method for capturing semantic information and generating an associated position marker to index that semantic information. As described in detail below, a position marker serves as a bookmark within a sequence of video images. Each position marker indicates a time point within the sequence of video images and may be associated with one or more video images in the sequence.

The methods described here permit the use of a wide range of touch gestures for the capture of annotation information and generate a label that can be used to index the position marker and corresponding video content with minimum interaction, which is particularly advantageous in live video preview as video images are being captured by the camera 220. During position marker creation the device 901 can be configured to determine semantics of interaction through multi-touch operation by monitoring temporal properties of (i) underlying video signals and (ii) spatial properties of a multi-touch gesture.

During the production stage 130, the interface 300 allows directors of the film to review the captured shots and record annotations made on the video preview area 310. The annotations may include possible issues or general comments on the shots. Annotations that the directors are interested in can be classified into a number of categories. Categories may be assigned to annotations using the interface elements 331-335. Typical categories of annotations may comprise performance, camera (image capture apparatus) parameters and quality. The performance category includes annotations relating to characters of the film. Example annotation types include script, voice and character positioning. Camera parameter annotations may include annotation types such as framing and zoom speed.

The term ‘framing’ refers to selection of what to include in a scene captured using the camera 220. Expressive qualities of framing include an angle of the camera 220 to an object of the scene, an aspect ratio of the projected image, and the like.

The term ‘zooming’ refers to a change of focus length of a lens of the camera 220 while the shot is in progress. Different effects may be created by different zooming speed. For example, zooming in creates a feeling of seemingly “approaching” a subject of the shot while zooming out makes an audience feel that they are seemingly “distancing” the subject. Quality annotation types relate to issues of quality of the video sequence captured by the camera 220 such as blur and focus. Different quality requirements may affect the camera movements. For example, a smooth camera pan may allow the scene to be sharp enough for the audience to observe, whereas a fast pan may create motion blur to the scene. Such information may be used in adjusting camera movement when making the next shot. The abovementioned annotations may provide some guidance at the production stage 130 as to how to improve shooting the next shot, or at the post-production stage 140 to improve editing.

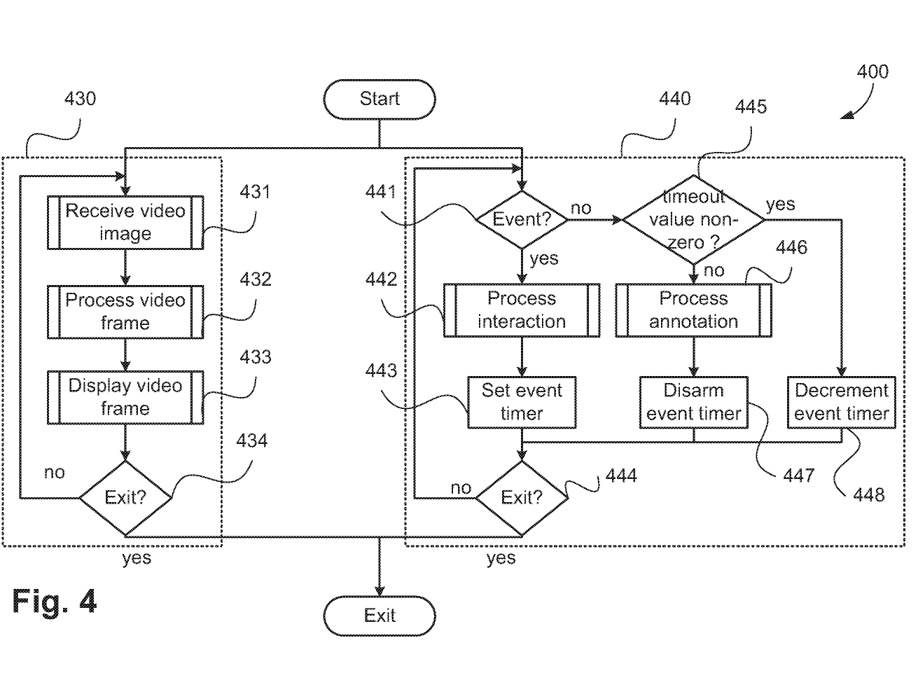

The application interface area 301 also contains a position markers list 320 which contains a list of labels (i.e., 321, 322, 323) which can be used to directly specify time points in the captured video images for a currently loaded shot along with annotation data that has been recorded during or after the take. The creation of the position markers, the construction of the position marker labels and the inclusion of the position marker labels into the position markers list 320 is now described in detail with reference to FIGS. 4-7.

A method 400 of viewing and applying an annotation to a portion of a sequence of video images being reviewed on the touch-sensitive display 914 of the device 901 is shown in FIG. 4. The method 400 may be implemented by one or more sub-modules of the application 933 stored on the memory 906, and being controlled in its execution of the processor 905 of the device 901.

In the preferred implementation, the method 400 is executed during live review of video content in the form of the sequence of video images being reviewed (i.e., as the video images are being captured by the camera 220 and displayed on the display 914). The method 400 thus may be executed as the device 901 is being used for displaying the sequence of video images on the touch-sensitive display 914.

In another arrangement, the method 400 is executed during displaying (or playing back) of the sequence of video images stored in the internal storage 909 or portable memory medium 925 after the sequence of video images has been previously captured by the camera 220. The video images to be displayed on the interactive display device 901 are accessed from the memory device in the form of the storage 909 or medium 925 prior to being displayed on the device 901.

The method 400 has two distinct threads of execution, a first thread 430 configured for the fetching and displaying the video images (or ‘frames’) captured (or ‘recorded’) by the camera 220, and a second thread 440 configured for processing touch events resulting from user interaction with the interactive display device 901.

The thread 430 starts at a receiving step 431, where a video image of the sequence of video images being reviewed is received by the device 901 under execution of the processor 905. Data for the video image is received at the step 431 in real-time from the camera 220. Then processing step 432 is executed by the processor 905 to decode and analyse the video image, the decoded video image being displayed on the touch-sensitive display 914 at step 433 in near real-time to a user of the device 901. Steps 431, 432 and 433 are repeated until a signal is provided to exit the method 400 implemented by the application 933. The signal to exit is tested for at testing step 434.

At any time during display of the video sequence on the touch-sensitive display 914, the user is able to initiate an annotation or other role-dependent function by executing one of a defined set of multi-touch gestures to operate the touch-sensitive display 914. The thread 440 is configured for recording (i.e., capturing and storing) and processing the multi-touch gestures. The thread 440 executes on the processor 905.

At testing step 441, the touch-sensitive display 914 operates under execution of the processor 905 to determine that a touch event has been executed by the user in real-time during capture and display of the video images of the video sequence on the touch-sensitive display 914. If a touch event resulting from an interaction (or contact) or a plurality of interactions (or contacts) made by the user with the touch-sensitive display 914 is determined, then the method 400 proceeds to processing step 442. The interaction determined at step 441 occurs on the displayed video images during the displaying of the video images in the video preview area 310. At step 442, the details of the touch, which include the number of touch points made by the interactions of the user with the touch-sensitive display and the spatial position in the form of x, y coordinates of the touch points, are processed. Otherwise, (i.e., if no touch event is determined), the method 400 proceeds to step 445.

Based on a determination made in the processing step 442, a time-out value is set in an event timer at setting step 443. The event timer may be configured within the memory 906. The time-out value is used to allow the user to break contact with the touch-sensitive display 914 during the entry of an annotation without ceasing the annotation. Depending on the nature of the interaction (or contact), such as a temporal property of the interaction as determined by the speed at which the interaction was made, the time-out value for annotation entry can be changed to provide the best balance between intuitive operation and fast initiation of additional independent annotations. The time-out value may also be dependent on the temporal properties of the video content at which the interaction was made. The temporal properties of video content in the form of a sequence of video images may be the frame rate of the sequence or the motion of objects in the video content or the movement of the camera 220 during the capture of the video images. For example, if there is a slow moving object in the video image, the time-out value is increased.

The time-out value set in the event timer at step 443 is tested at step 445. In any cycle of execution of the thread 440, if no touch event is determined at step 441, the value of the event timer is tested at step 445. If the timeout value in the event timer is non-zero, indicating the specified duration has not lapsed, the event timer is decremented at decrementing step 448 by a quantity equivalent to the time that has lapsed since the event timer was last tested.

If the timeout value of the event timer has reached zero then the thread 440 asserts that an annotation has been completed and executes processing step 446 in response. Once an annotation has been completed, the event timer is disarmed so that the timeout value is ignored until reactivated again at step 442 after a subsequent touch event.

As with thread 430, thread 440 cycles until a signal is received indicating that the method 400 implemented by the application 933 should exit. The exit signal is tested for at testing step 444. In an alternative implementation, the time-out mechanism may employ a hardware timer which implements step 448 as a hardware operation. Such a timer may generate an event when the timer has been fully decremented as would be detected at step 445.

The threads 430 and 440 provide an overall framework within which the tasks of review, annotation and bookmarking are performed. The method 400 can be applied to other film production functions, and some of the functions may require details of the touch input to be sent to the image capture device in the form of the camera 220. For example, a 1⁴ assistant camera may use the device 901 to adjust the focus parameters of the camera equipment 220. In such a case, the coordinates of the contacts will be sent to the camera 220.

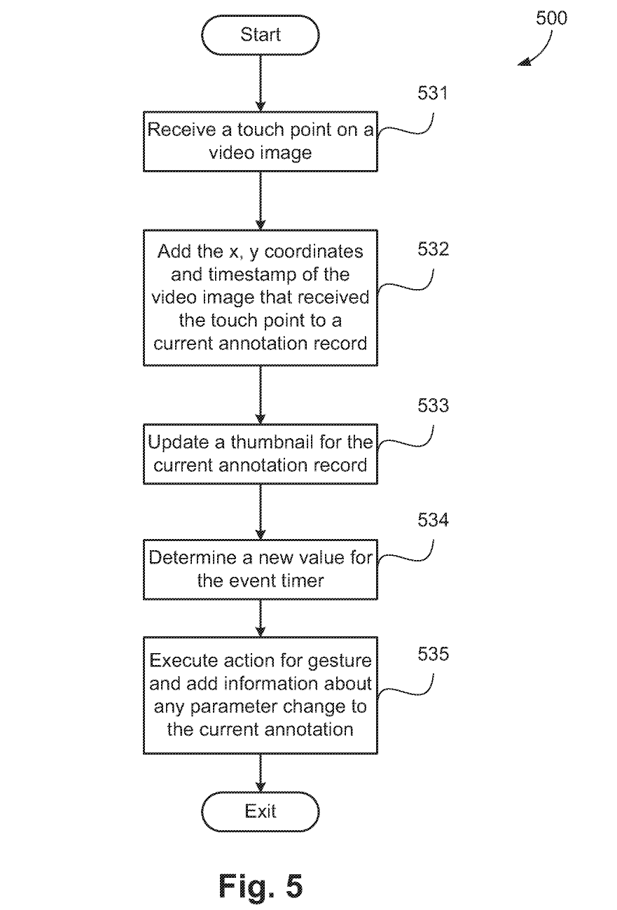

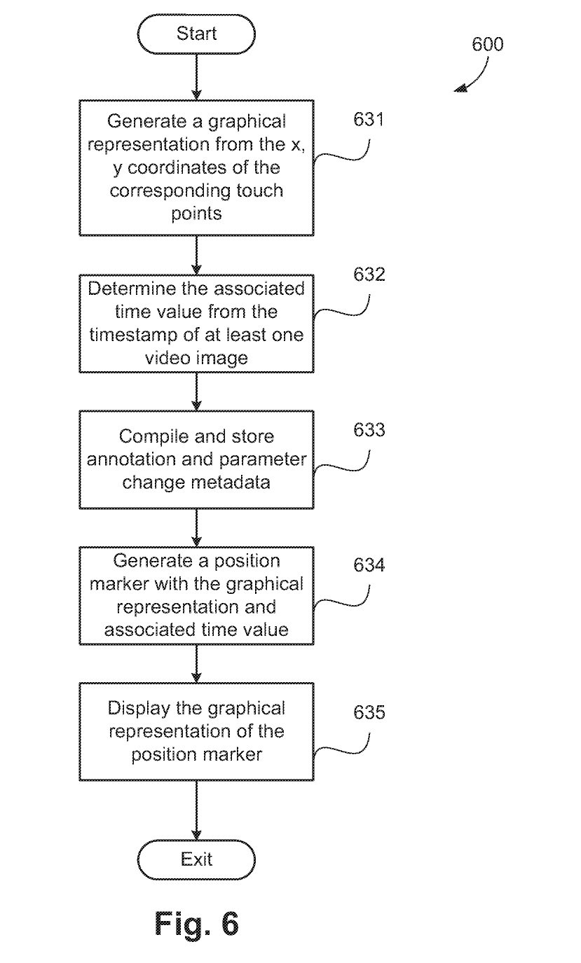

The annotation and bookmarking are performed at processing steps 442 and 446 which are described in detail below. A method 500 of processing annotation data including atomic components of a touch event and associated user interactions such as a new contact, a movement or a break of contact, as executed at step 442, will be described in detail below with reference to FIG. 5. atomic components of a touch event (or events) and associated interactions that form the annotation are accumulated and the atomic components of the touch event are processed to determine a duration that can be used to determine an end to the annotation gesture. Once a break in the annotation gesture is identified, the generation of the annotation and the generation of an associated position marker in a sequence of video images are performed at step 446. A method 600 of generating a position marker, as executed at step 446, will be described in detail below with reference to FIG. 6. The position marker generated serves to bookmark the portion of the sequence of video images. The position marker is associated with at least one time value determined from the interaction relative to one or more of the video images displayed on touch-sensitive display 914. As described below, the position marker may be labelled with a graphical representation of the determined interaction, the graphical representation indicating relative spatial position of the determined interaction on the video image. The graphical representation may be displayed over the video image The graphical representation may also include a label representing the spatial position of the determined interaction.

The method 500 of processing annotation data, as executed at step 442, will now be described in detail with reference to FIG. 5. The method 500 may be implemented by one or more sub-modules of the application 933 stored on the memory 906, and being controlled in its execution of the processor 905 of the interactive display device 901.

The method 500 begins at receiving step 531, where the spatial position in the form of x, y coordinates of a touch point made from one or more interactions (or contacts) by the user on the touch-sensitive display 914 are received under execution of the processing. The coordinates of the touch point are determined relative to the display position of a video image corresponding to the touch point (i.e., a video image currently being displayed on the display 914 when the interaction occurred). In addition, a timestamp associated with the video image corresponding to touch point is determined The timestamp is usually generated by the timing synchronization system in processor 905 at regular intervals, usually the same interval between consecutive video images that is inversely proportional to the frame rate of the sequence of video images. In film productions, the timestamp is often in the form of an SMPTE timecode. The video image corresponding to the touch point will be referred to below as the ‘current video image’.

The coordinates of the touch point, expressed in the video image coordinate system, and timestamp information are added to a current annotation record at adding step 532. The annotation record may be configured within the memory 906.

At step 533 a thumbnail image, based on the touch points received for the annotation and current video image, is also created or updated. The thumbnail image may be created once based on the video image contents at the start of the annotation. In alternative implementations, the thumbnail image may be updated during the annotation or a sequence of thumbnails accumulated. In another implementation, the thumbnail image may not be a low-resolution version of the current video image data, but a graphical representation of the coordinates of the touch points received as part of a current multi-gesture operation.

At determining step 534, a time interval is determined for use in an event timer for detecting an event time-out value. The time interval determined at step 534 may also be referred to as the ‘time-out’ interval. The determination of the time interval at step 534 is based on a type of the current touch event. If a contact is stopped, the time interval is determined to be a function of the distance, and hence speed, of previous move operations. Accordingly, responsiveness of the system 200 reacts in a natural way to the apparent urgency with which annotations are being made. In another implementation, the time interval may be a predetermined value, which may be based on the characteristics of the scene to be produced or a history of previously used time-out values.

Then at executing step 535, an action is executed to control some aspect of the system 200. Step 535 may only be executed for certain roles such as the camera operator. The result of the action, including the parameter changed and any status information (e.g., communication status, success or failure status of the action) associated with making the change, are also recorded (i.e., captured and stored) as part of the annotation record. A user may also provide additional information in the form of text, audio recording, etc. For example, the 1^{st} camera assistant may associate the touch points with names as descriptive cues.

The method 600 of generating a position marker, as executed at step 446, will now be described with reference to FIG. 6. As described above, the position marker generated serves to bookmark the portion of the sequence of video images currently being reviewed (i.e., displayed) on the touch-sensitive display 914 of the device 901. The method 600 may be implemented by one or more sub-modules of the application 933 stored on the memory 906, and being controlled in its execution of the processor 905 of the interactive display device 901.

The method 600 collects a set of touch events and associated interactions after a timeout event has occurred and generates the annotation, label and position marker that indexes the annotation into the sequence of video images. The set of touch events and associated interactions may be determined for the position marker based on the temporal properties of the interactions. Alternatively, the set of touch events and associated interactions may be determined for a position marker based on the temporal properties of the video images. The temporal properties of video images are, for example; the frame rate of the sequence or the motion of objects in the video images or the movement of the camera 220 during the capture of the video images. For example, if the camera is moving quickly, the touch events would be grouped into smaller sets.

At determining step 631, a graphical representation of the collection of touch events comprising the annotation is generated. For each touch event and associated interaction (or interactions) within the annotation an event type determines a graphical element which is drawn into the graphical representation at the x, y coordinates of touch points corresponding to the touch event. The touch event type is determined by the type of interaction made by the user on the touch-sensitive display 914 of the device 901. For example, a draw touch event comprising a drawing interaction involves the user moving a finger while in contact with the display 914, and will result in a line being drawn into the graphical representation. Other touch events may be associated with interactions including multi-touch gestures by the user of the device 901 and will produce different graphical elements. For example, a pinch may result in a pair of arrows being drawn such that the points of the arrows converge. As another example, in one arrangement, the determined graphical representation depends on temporal properties of the touch event and associated interaction. For example, a short touch of the touch-sensitive display 914 by the user may result in a bulls-eye being drawn. Such graphical elements are also drawn during the touch event to provide the user with an intuitive visual correspondence. The graphical representation of the annotation is not cropped in any way and thus retains its spatial position relative to the x, y coordinates of one or more video images corresponding to the annotation, which in turn adds descriptive information to the graphical representation. Such descriptive information allows the user to distinguish between similar annotations entered at different time points in the sequence of video images. In one implementation, the graphical representation of the annotation is further combined with thumbnail data (e.g., a thumbnail image) for the annotation as accumulated during the method 500.

Subsequently at determining step 632, a time value is determined corresponding to the timestamp of at least one captured video image corresponding to the annotation period. In a preferred implementation, the corresponding video image is the video image which is currently being displayed on the touch-sensitive display 914 (i.e., the current video image) at the time the annotation was commenced. However, the corresponding video image may also be a video image displayed on the touch-sensitive display 914 at a predetermined time interval prior to a first touch event in the annotation. Accordingly, an advantage of the method 600 is that greater context is provided to the annotation which is especially useful during review.

At compiling step 633, the annotation data is compiled, along with any parameter change that has occurred as a consequence of the gestural interaction (or interactions) made by the user of the device 901 with the touch-sensitive display 914. The annotation data forms an annotation record that can be stored within the memory 906.

At generating step 634, a position marker is generated under execution of the processor 905. The generated position marker comprises an index into the current video image at the timestamp determined at step 633. The generated position marker contains the annotation record, which has data sufficient to reproduce the annotation sequence and the graphical representation of the annotation sequence determined is used as a label for the position marker.

If interactions are used by the user to annotate the video sequence, where drawing strokes is displayed in the video preview area 310, then the graphical representation generated at step 631 may directly replicate the inking and include the spatial position of strokes corresponding to the relative position of the interactions to the video images. Label 321 illustrates an example of a graphical representation of drawing strokes used for annotation. In another implementation, if interactions are used by the user to adjust the focus plane of lens on the camera 220, then a circular graphical representation (such as the icon in Label 322) may be generated at step 631. The spatial position of the circular graphical representation corresponds to the relative position (i.e., associated with one or more touch points) corresponding to the interactions with the current video image. Any graphical representation that is suitable to the functions performed by user interactions may be generated at step 631 as described in more detail below.

In one implementation, the graphical representation generated at step 631 may be used to reflect the temporal duration of interactions by the user. For example, a longer rippling effect may be used for interactions that was created over an extended period of time.

In one implementation, the graphical representation generated at step 631 may depend on the role of a user making the interactions with the touch-sensitive display 914 of the interactive display device 901. For example, if the user is the director of a film being produced, the graphical representation may include a thumbnail image of a director's chair, loud-speaker or the like.

In one implementation, the graphical representation generated at step 631 may depend on a function performed as a result of interactions of the user with the touch-sensitive display 914 of the device 901. For example, where the device 901 comprises a designated camera control function and interaction results in a focus function being performed on the camera 220, then the graphical representation may be of a circular shape (e.g., the icon in Label 322). In another example, where the device 901 comprises a designated camera control function and interaction results in a light measuring function being performed on the camera 220, the graphical representation may be of a rectangular shape to indicate the measuring area (e.g., the icon in Label 324). The graphical representation generated at step 631 may further be used to indicate the results of communication with the camera 220 or the results of execution (i.e., execution status) of the functions performed either locally on the device 901 or remotely on the camera 220. For example, green colour may be used to indicate execution with a success result; whereas red colour may be used to indicate executions that failed.

The method 600 concludes at displaying step 634, where the graphical representation generated in accordance with the method 600 is subsequently displayed on the touch-sensitive display 914 in the position markers list 320 as seen in FIG. 3.

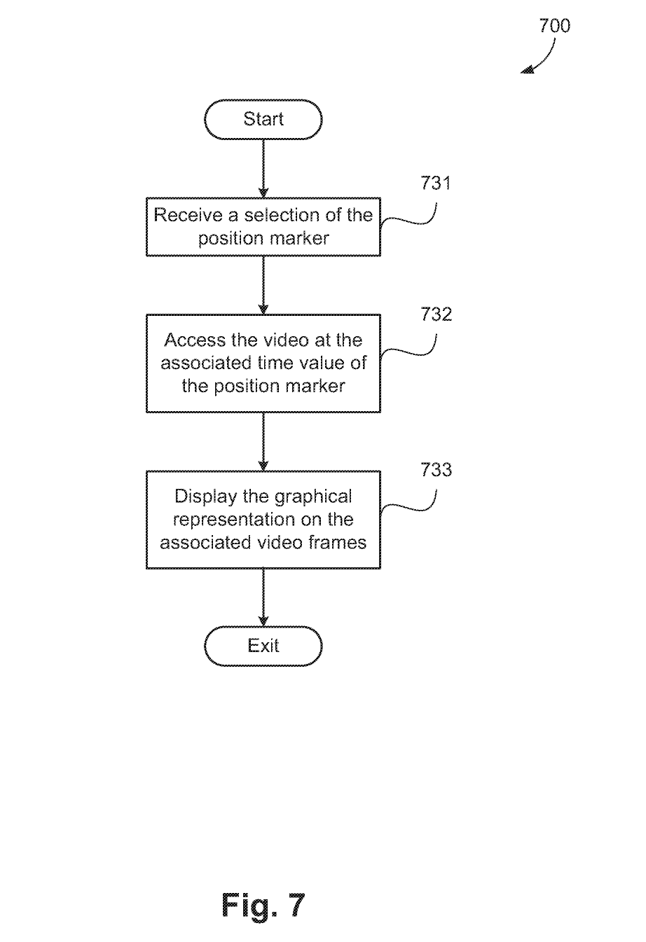

The use of the generated position marker is described with reference to FIG. 7 which shows a method 700 of accessing video and annotation data for a position marker. A user is able to select a position marker from the list 320 by selecting a corresponding label (e.g., 321) which comprises the graphical representation of the annotation generated in the method 600. The method 700 may be implemented by one or more sub-modules of the application 933 stored on the memory 906, and being controlled in its execution of the processor 905 of the interactive display device 901.

The method 700 begins at selecting step 731, where selection of a position marker is detected under execution of the processor 905. For example, the user may touch the label 322 as displayed on the touch-sensitive display 914 using a touch gesture. At accessing step 732, one or more video images corresponding to the position marker and an associated time value are retrieved under execution of the processor 905. Then at displaying step 733, the retrieved video images are displayed on the touch-sensitive display 914. In a preferred implementation, annotation strokes are played back synchronously with the retrieved video images so as to reproduce the annotation as the annotation was displayed when entered by the user.

In one implementation, upon selecting the position marker, as at step 731, tags, audio notes, text notes and the like, may be added to the annotation corresponding to the position marker. The graphical representation associated with the position marker may be dependent on the annotation attributes, such as categories, tags, audio notes, text notes and the like. For example, the graphical representation may include an ‘A’ where the annotation associated with the selected position marker is an audio annotation; or the graphical representation may include a ‘T’ where the annotation associated with the selected position marker is a text annotation.

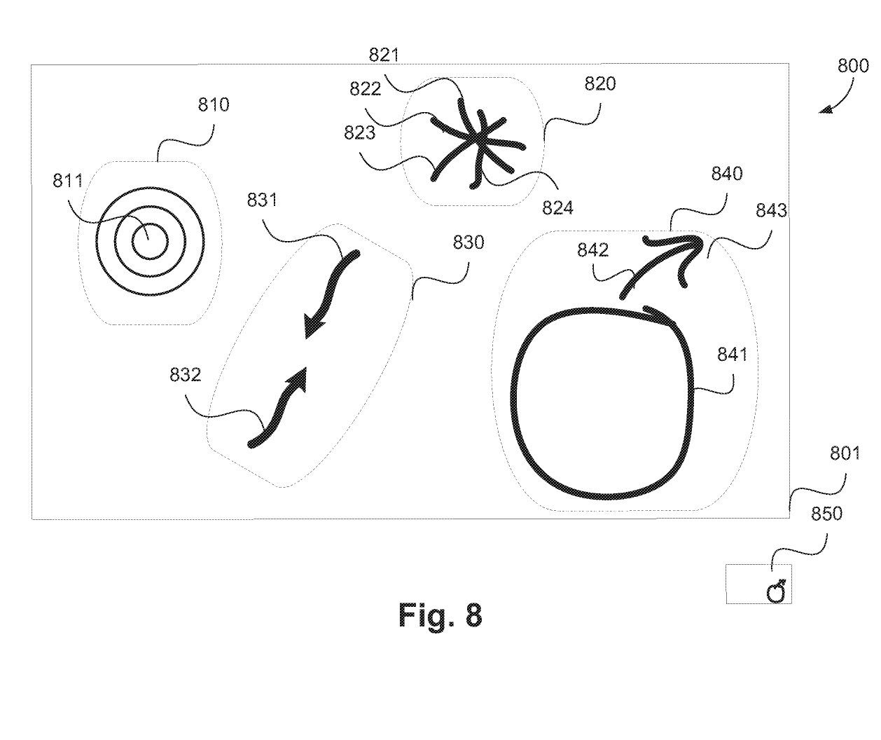

Example of touch events and associated interactions together with resulting annotations and mapping of the touch events to a graphical representation are further described with reference to FIG. 8.

FIG. 8 shows a video display area 800 which may be displayed on the touch-sensitive display 914. The display area 800 shows four (4) independent examples of annotations 810, 820, 830 and 840 that are representative of touch events and associated user interactions described above.

FIG. 8 shows an annotation 810 resulting from a single touch event comprising a single touch interaction at touch point 811, which is represented graphically by a set of concentric circles centred at touch point 811. Such an annotation is also represented in the label 322 of the bookmark list 320 as seen in FIG. 3.

Annotation 830 comprises a multi-touch gesture—in this case a pinch action—which is represented by two converging arrow tipped lines, 831 and 832, which capture start and end points of the pinch gesture.

As further examples, because of the use of an event timer as described above during the annotation capture, an annotation may also comprise a set of sequential touch events including associated interactions. For example, annotation 820 comprises a series of overlapping strokes 821, 822, 823 and 824, drawn in quick succession to create a “*” symbol. Note that the strokes 821, 822, 823 and 824, are not constrained to overlap. For example, for annotation 840, because strokes 841, 842 and 843 are entered without exceeding the timeout interval as determined at step 534 of method 500, the strokes 841, 842 and 843 are considered to be part of the same annotation 840.

FIG. 8 also shows an example graphical representation 850 of an annotation such as would be used in a label (e.g., label 321) for a generated position marker corresponding to annotation 840.

The described methods thus provide efficient bookmarking and annotation methods for use during capture and real-time review of a sequence of video images. As described above, the annotation strokes entered by the user during interactions with the interactive display device 901 are used, in combination with the touch event type and associated interaction(s), to construct a graphical label (e.g., 321, 322, 323) for the annotation, including relative position of the annotation within a video image of the sequence. The described methods allow a position marker into the video images of the video sequence to be constructed with a bare minimum of user interaction, allowing the user to focus on content and annotation tasks free from additional housekeeping tasks that would otherwise be required. The described methods are responsive to the rate of interaction of the user while providing a completely flexible annotation language. As a result, the user is able to develop a purpose specific annotation language which can be both graphical and intuitive and the user is unburdened by non-core tasks such as textual naming or tagging.

### INDUSTRIAL APPLICABILITY

The arrangements described are applicable to the computer and data processing industries and particularly for the image processing.

The foregoing describes only some embodiments of the present invention, and modifications and/or changes can be made thereto without departing from the scope and spirit of the invention, the embodiments being illustrative and not restrictive.

1. A method of generating a position marker in video images, said method comprising:
displaying the video images on an interactive display device;
determining an interaction with the interactive display device on the displayed video images during the display of the video images;
generating the position marker, wherein the position marker is associated with at least one time value determined from the interaction relative to at least one of said video images and is labelled with a graphical representation of the interaction, the graphical representation indicating relative spatial position of the determined interaction on said video image.

2. The method according to claim 1, further comprising determining a set of interactions for the position marker based on temporal properties of the interactions, wherein the position marker is associated with at least one time value determined from the set of interactions relative to at least one of said video images and is labelled with a graphical representation of the set of interactions, the graphical representation indicating relative spatial position of the determined set of interactions on said video image.

3. The method according to claim 1, further comprising determining a set of interactions for the position marker based on the temporal properties of the video images, wherein the position marker is associated with at least one time value determined from the set of interactions relative to at least one of said video images and is labelled with a graphical representation of the set of interactions, the graphical representation indicating relative spatial position of the determined set of interactions on said video image.

4. The method according to claim 1, wherein the graphical representation includes a representation of the path traced out by the determined interaction.

5. The method according to claim 1, wherein the graphical representation depends on temporal properties of the interaction.

6. The method according to claim 1, wherein the graphical representation depends on a role of the user making the interaction.

7. The method according to claim 1, wherein the graphical representation depends on a function of the interaction.

8. The method according to claim 1, wherein the graphical representation depends on an execution status of a function of the interaction.

9. The method according to claim 7, wherein the function of the interaction is performed by at least one of the interactive display device or an image capture device and wherein the function is one of annotation, focus control, or light measurement.

10. The method according to claim 8, wherein the function of the interaction is performed by at least one of the interactive display device or an image capture device and wherein the function is one of annotation, focus control, or light measurement.

11. The method according to claim 1, wherein the graphical representation is dependent on annotation attributes.

12. The method according to claim 1, further comprising displaying the graphical representation of the interaction over the video images as the interaction is determined.

13. The method according to claim 11, wherein the video images are displayed on the interactive display device as the video images are being captured.

14. The method according to claim 11, wherein the video images are accessed from a memory device prior to being displayed on the interactive display device.

15. The method according to claim 11, further comprising displaying the position marker on the interactive display device.

16. The method according to claim 1, wherein upon selection of the position marker, the graphical representation of the interaction is played back over the video images.

17. An apparatus for generating a position marker in video images, said apparatus comprising:
display module for displaying the video images on an interactive display device;
determining module for determining an interaction with the interactive display device on the displayed video images during the display of the video images;
generating module for generating the position marker, wherein the position marker is associated with at least one time value determined from the interaction relative to at least one of said video images and is labelled with a graphical representation of the interaction, the graphical representation indicating relative spatial position of the determined interaction on said video image.

18. A system for generating a position marker in video images, said system comprising:
a memory for storing data and a computer program;
a processor coupled to the memory for executing the computer program, the computer program comprising instructions for:
displaying the video images on an interactive display device;
determining an interaction with the interactive display device on the displayed video images during the display of the video images;
generating the position marker, wherein the position marker is associated with at least one time value determined from the interaction relative to at least one of said video images and is labelled with a graphical representation of the interaction, the graphical representation indicating relative spatial position of the determined interaction on said video image.

19. A non-transitory computer readable medium having a computer program stored thereon for generating a position marker in video images, said program comprising:
code for displaying the video images on an interactive display device;
code for determining an interaction with the interactive display device on the displayed video images during the display of the video images;
code for generating the position marker, wherein the position marker is associated with at least one time value determined from the interaction relative to at least one of said video images and is labelled with a graphical representation of the interaction, the graphical representation indicating relative spatial position of the determined interaction on said video image.
